(19) United States
(12) Patent Application Publication
(10) Pub. No.: US 2011/0012889 A1
(43) Pub. Date: Jan. 20, 2011

(54) ELECTRO-OPTICAL APPARATUS, ELECTRONIC APPLIANCE, AND METHOD OF DRIVING ELECTRO-OPTICAL APPARATUS

(75) Inventor: Tsutomu MIYAMOTO, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/827,096

(22) Filed: Jun. 30, 2010

(30) Foreign Application Priority Data
Jul. 17, 2009 (JP) 2009-169266

(51) Int. Cl. G09G 5/00

(52) U.S. Cl. 345/212

(57) ABSTRACT

An apparatus includes: a first pixel having a first transistor, a first pixel electrode and a first common electrode; a second pixel having a second transistor, a second pixel electrode and a second common electrode; first and second scanning lines connected to the first and second transistors, respectively; a first data line connected to the first and second transistors; common electrode wiring connected to the first and second common electrodes; and a driving circuit. The first transistor's on/off state is selected according to a voltage between the first scanning line and the first data line. The second transistor's on/off state is selected according to a voltage between the second scanning line and the first data line. The driving circuit selects the first transistor's on/off state, then selects the second transistor's on/off state, and then simultaneously changes the first and second pixels' display states.

### BACKGROUND

1. Technical Field

The present invention relates to an electro-optical apparatus, an electronic appliance and a method of driving an electro-optical apparatus.

2. Related Art

An electrophoretic apparatus displays an image by changing a voltage applied between electrodes sandwiching therebetween charged electrophoresis particles, which causes the electrophoresis particles to move, and the color of the exterior of the apparatus is thereby changed and held. When an electro-optical apparatus, as an example of such an electrophoretic apparatus, changes the voltage applied between the electrodes, the electro-optical apparatus changes the on/off state of thin-film transistors by changing the voltages applied to the thin-film transistors from scanning lines and data lines.

According to a known technology, the gate-insulating layer of such a thin-film transistor is formed from a ferroelectric material and the polarization state of the gate-insulating layer can be changed. For example, a technology in which the gate-insulating film of a thin-film transistor in an organic EL active-matrix display apparatus is formed from a ferroelectric material is disclosed in JP-A-61-260596. An organic ferroelectric memory configured using thin-film transistors, which have an organic ferroelectric layer, is disclosed in JP-A-2006-253474. Furthermore, a transistor that can control a threshold voltage is disclosed in JP-A-2005-228968.

However, regarding the above-mentioned known technology in which the gate-insulating film of a thin-film transistor is formed from a ferroelectric material and the polarization state of the gate-insulating film can be changed, a driving method to be used when applying the technologies to an electro-optical apparatus including an electrophoretic apparatus has yet to be established. Thus, there is a problem in that time is required when changing the display of the electro-optical apparatus.

### SUMMARY

An advantage of some aspects of the invention is that it provides an electro-optical apparatus and a method of driving an electro-optical apparatus with which it is possible to shorten the time required to change the display of an electro-optical apparatus.

An electro-optical apparatus according to a first aspect of the invention includes: a first pixel having a first transistor, a first pixel electrode and a first common electrode that opposes the first pixel electrode; a second pixel having a second transistor, a second pixel electrode and a second common electrode that opposes the second pixel electrode; a first scanning line that is electrically connected to the first transistor; a second scanning line that is electrically connected to the second transistor; a first data line that is electrically connected to the first transistor and the second transistor; common electrode wiring that is electrically connected to the first common electrode and the second common electrode; and a driving circuit that controls voltages applied to the first scanning line, the second scanning line, the first data line and the common electrode wiring. Here, a switching characteristic of the first transistor and a switching characteristic of the second transistor have hysteresis; an on state or an off state is selected as a conduction state of the first transistor in accordance with a voltage applied between the first scanning line and the first data line; an on state or an off state is selected as a conduction state of the second transistor in accordance with a voltage applied between the second scanning line and the first data line; and the driving circuit is configured to be capable of selecting the on state or the off state as the conduction state of the first transistor, then selecting the on state or the off state as the conduction state of the second transistor, and then simultaneously changing a display state of the first pixel and a display state of the second pixel from a first display state to a second display state.

Furthermore, according to a second aspect of the invention, provided is a method of driving an electro-optical apparatus having a first pixel including a first transistor, a first pixel electrode and a first common electrode that opposes the first pixel electrode; a second pixel including a second transistor, a second pixel electrode and a second common electrode that opposes the second pixel electrode; a first scanning line that is electrically connected to the first transistor; a second scanning line that is electrically connected to the second transistor; a first data line that is electrically connected to the first transistor and the second transistor; common electrode wiring that is electrically connected to the first common electrode and the second common electrode; and a driving circuit that controls voltages applied to the first scanning line, the second scanning line, the first data line and the common electrode wiring; a switching characteristic of the first transistor and a switching characteristic of the second transistor having hysteresis. The method includes selecting an on state or an off state as a conduction state of the first transistor in accordance with a voltage being applied between the first scanning line and the first data line; selecting an on state or an off state as a conduction state of the second transistor in accordance with the voltage applied between the second scanning line and the first data line; and controlling the voltages applied to the first scanning line, the second scanning line, the first data line and the common electrode wiring so as to simultaneously change the display state of the first pixel and the display state of the second pixel from a first display state to a second display state.

In known electro-optical apparatuses, a method has been used in which for example the display state of each pixel formed on one scanning line among a plurality of scanning lines is changed and once the display states of all of the pixels have been changed, the display state of each pixel formed on the subsequent scanning line is changed. Here, in order to change the display states of all the pixels on a single scanning line, for example a time on the order of several milliseconds has been necessary and therefore to change the display states of all the pixels of an electro-optical apparatus a time on the order of (several milliseconds)×(the number of scanning lines) has been necessary. This time for example is on the order of several seconds when one thousand scanning lines are included in an electro-optical apparatus.

With the above-described electro-optical apparatus according to the first aspect of the invention and the method of driving an electro-optical apparatus according to the second aspect the invention, the switching characteristic of the transistor of the first pixel and the switching characteristic of the transistor of the second pixel have hysteresis and first an on state or an off state is selected as a conduction state of the transistor of the first pixel in accordance with the voltage applied between the first scanning line and the first data line. Furthermore, an on state or an off state is also selected for the transistor of the second pixel. Next, the display states of the first and second pixels are simultaneously changed. Here, in the first and second aspects of the invention, the time required to change the conduction state of a transistor is on the order of for example several microseconds. Accordingly, the time required to change the display states of all of the pixels of the electro-optical apparatus is on the order of (several microseconds)×(the number of scanning lines)×(the time required to change the display state). The time required to entirely change the display state of the electro-optical apparatus is longer than the time it takes to change the display states of all pixels on a single scanning line and is on the order of several tens of to several hundred milliseconds. That is, the time it takes to change the display states of all the pixels of the electro-optical apparatus is on the order of (several milliseconds)+(several tens of to several hundred milliseconds) in the case of for example an electro-optical apparatus having one thousand scanning lines. Thus, with the electro-optical apparatus having the above-described configuration, the time it takes to change the display states of pixels included in the electro-optical apparatus can be shortened.

Furthermore, the driving circuit of the electro-optical apparatus is preferable configured so as to be capable of controlling voltages applied to the first scanning line, the second scanning line, the first data line and the common electrode wiring so as to simultaneously change the display state of the first pixel and the display state of the second pixel from the second display state to the first display state and then change the conduction state of the first transistor and the conduction state of the second transistor to the on state or the off state.

In addition, the method of driving the electro-optical apparatus preferably further includes controlling voltages applied to the first scanning line, the second scanning line, the first data line and the common electrode wiring so that the driving circuit simultaneously changes the display states of the first pixel and the second pixel from the second display state to the first display state and then changes the conduction state of the first transistor and the conduction state of the second transistor to the on state or the off state.

With the electro-optical apparatus having the above-described configuration and the method of driving the electro-optical apparatus, the display states of all of the pixels can be changed to the first display state and the conduction states of all of the transistors can be changed to a predetermined state in a short time.

Furthermore, the electro-optical apparatus is preferably configured so that the first pixel further includes pixel particles that are provided between the first common electrode and the first pixel electrode;

the second pixel further includes pixel particles that are provided between the second common electrode and the second pixel electrode; and the driving circuit is preferably configured so as to periodically change the voltage applied between the first common electrode and the first pixel electrode and the voltage applied between the second common electrode and the second pixel electrode between a first voltage and a second voltage when simultaneously changing the display state of the first pixel and the display state of the second pixel from the first display state to the second display state.

In the method of controlling the electro-optical apparatus, in the electro-optical apparatus, the first pixel preferably further include pixel particles provided between the first common electrode and the first pixel electrode, the second pixel preferably further includes pixel particles provided between the second common electrode and the second pixel electrode, and when controlling the voltages applied to the first scanning line, the second scanning line, the first data line and the common electrode wiring, it is preferable that the driving circuit periodically change the voltage applied between the first common electrode and the first pixel electrode and the voltage applied between the second common electrode and the second pixel electrode between a first voltage and a second voltage.

With the electro-optical apparatus having the above-described configuration and the method of driving the electro-optical apparatus, when changing the display states of the first pixel and the second pixel, the driving circuit periodically changes the voltage applied between the first common electrode and the first pixel electrode and the voltage applied between the second common electrode and the second pixel electrode between a first voltage and a second voltage. Thus, the pixel particles can be caused to move while being subjected to electrical oscillation due to the voltage being applied between the common electrodes and the pixel electrodes being periodically changed when changing the display states of the pixels. Accordingly, the pixel particles can be caused to move while remaining moderately dispersed and the contrast of the pixels can be increased.

Furthermore, an electronic appliance according to a third aspect of the invention includes the electro-optical apparatus according to the first aspect of the invention.

In addition, in the method of driving the electro-optical apparatus, in selectively changing the conduction state of the first transistor to an on state or an off state, the driving circuit preferably puts the second scanning line into a high-impedance state.

With this method, since the second scanning line connected to a transistor maintaining the same polarization state is in a high-impedance state, the polarization state of the transistor desired to be maintained in the same polarization state can be prevented from unexpectedly changing.

Furthermore, in the method of driving the electro-optical apparatus, the electro-optical apparatus preferably further includes a third pixel having a third transistor that is electrically connected to the first scanning line, a third pixel electrode and a third common electrode that opposes the third pixel electrode, and preferably further includes a second data line that is electrically connected to the third transistor. In addition, it is preferable that a switching characteristic of the third transistor have hysteresis; that the voltage applied to the second data line be controlled by the driving circuit; that an on state or an off state be selected as a conduction state of the third transistor in accordance with a voltage applied between the first scanning line and the second data line; and that, in selecting an on state or an off state as a conduction state of the first transistor, the conduction state of the third transistor be maintained without being changed by putting the second data line into a high-impedance state.

With this method, since the second data line connected to a transistor maintains in the same polarization state is in a high-impedance state, the polarization state of the transistor desired to be maintained in the same polarization state can be prevented from unexpectedly changing.

### BRIEF DESCRIPTION OF THE DRAWINGS

The invention will be described with reference to the accompanying drawings, wherein like numbers reference like elements.

FIG. 1 is a diagram illustrating an example configuration of an electro-optical apparatus.

FIG. 2 is a diagram illustrating an example configuration of a pixel of the electro-optical apparatus.

FIG. 3 is a diagram illustrating a first example configuration of a transistor having hysteresis.

FIG. 4 is a diagram illustrating voltage-current characteristics of a transistor having hysteresis.

FIG. 5 is a diagram illustrating a second example configuration of a transistor having hysteresis.

FIG. 6 is a first diagram illustrating the changes with time of voltages applied to respective lines and the polarization states of transistors.

FIG. 7 is a diagram illustrating the state of the electro-optical apparatus at time T2.

FIG. 8 is a diagram illustrating the state of the electro-optical apparatus at time T4.

FIG. 9 is a diagram illustrating the state of the electro-optical apparatus at time T6.

FIG. 10 is a diagram illustrating the state of the electro-optical apparatus at time T8.

FIG. 11 is a second diagram illustrating the changes with time of voltages applied to respective lines and the polarization states of transistors.

FIG. 12 is a diagram illustrating the state of the electro-optical apparatus at time T12.

FIG. 13 is a diagram illustrating the state of the electro-optical apparatus at time T14.

FIG. 14 is a diagram illustrating a first state in the second embodiment.

FIG. 15 is a diagram illustrating a second state in the second embodiment.

FIG. 16 is a perspective view of a mobile phone equipped with the electro-optical apparatus.

FIG. 17 is a perspective view of a video camera equipped with the electro-optical apparatus.

FIG. 18 is a perspective view of a television equipped with the electro-optical apparatus.

FIG. 19 is a perspective view of a roll-up-type television equipped with the electro-optical apparatus.

FIG. 20 is a perspective view of a personal computer equipped with the electro-optical apparatus.

### DESCRIPTION OF EXEMPLARY EMBODIMENTS

Hereafter, embodiments of the invention will be concretely described in the order listed below with reference to the attached drawings. Here, the embodiments to be described below are merely examples of the invention and in no way limit the technical scope of the invention. Furthermore, in each of the drawings, identical components are denoted by the same reference numbers and repeated description thereof is omitted.

1. Definitions

2. First Embodiment

2-1. Example configuration of electro-optical apparatus
2-2. Example configuration and characteristics of transistor included in electro-optical apparatus
2-3. Example operation of electro-optical apparatus

(1) Change of polarization states of transistors

(2) Change of display states

(3) Resetting of display states

(4) Resetting of polarization states of transistors

1. Second Embodiment

2. Example Electronic Appliances Including Electro-Optical Apparatus

3. Additional Information

### 1. DEFINITIONS

First, terms to be used in this specification are defined as follows.

“Pixel Particles”: This term refers to charged particles that are used to perform display and that are arranged between a common electrode and a pixel electrode in a pixel. Examples of such pixel particles include but are not limited to electrophoresis particles and electronic liquid powder particles.

“Electro-Optical Apparatus”: Examples of an electro-optical apparatus include but are not limited to an electrophoretic apparatus and an optical apparatus having pixels configured to include electronic liquid powder particles.

### 2. First Embodiment

### 2-1. Example Configuration of Electro-Optical Apparatus

This embodiment of the invention, which is one mode of carrying out the invention, relates to an electro-optical apparatus and in particular one characteristic thereof is that the switching characteristic of a transistor included in a pixel of the electro-optical apparatus has hysteresis. In this embodiment of the invention, a ferroelectric layer is provided between the gate electrode and the source electrode or the drain electrode of a transistor. The polarization state of the ferroelectric layer can be changed in accordance with the voltage applied thereto and the polarization state is maintained even when application of the voltage ceases. Consequently, the switching characteristic of the transistor exhibits hysteresis.

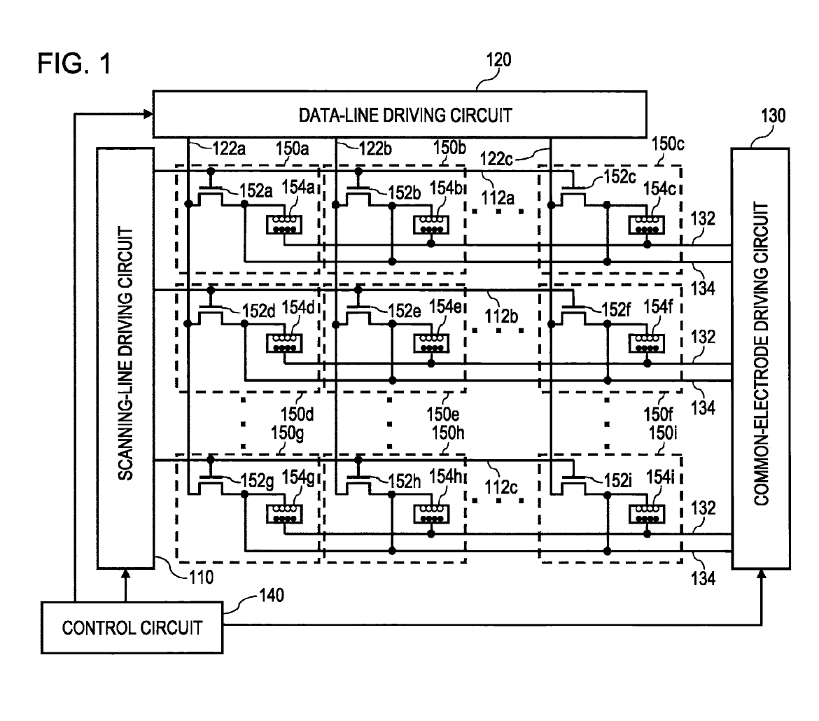

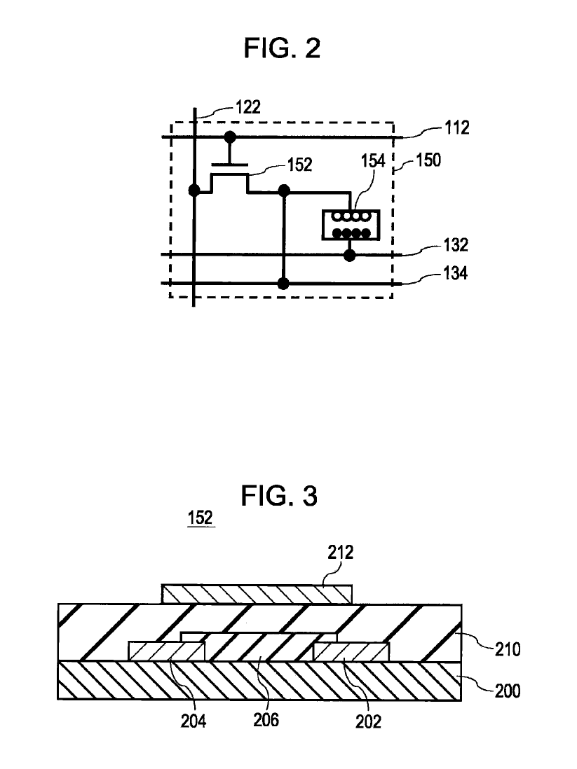

FIG. 1 is a diagram illustrating an example configuration of an electro-optical apparatus according to the present embodiment. FIG. 2 is a diagram illustrating one configuration of a pixel included in the electro-optical apparatus according to the embodiment.

As illustrated in FIG. 1, the electro-optical apparatus includes a plurality of pixels 150; driving circuits including a scanning-line driving circuit 110, a data-line driving circuit 120 and a common-electrode driving circuit 130; and a control circuit 140.

### Pixel 150

As illustrated in FIG. 2, each pixel 150 includes a transistor 152 and a pixel element 154.

### Pixel Element 154

The pixel element 154 is configured to include pixel particles, a dispersion medium, a pixel electrode and a common electrode. The common electrode is connected to the common-electrode driving circuit 130 via common electrode wiring 132. The pixel electrode is arranged so as to oppose the common electrode and is connected to the drain electrode of the transistor 152. The pixel particles are charged particles of two colors, for example, white and black, and are arranged between the common electrode and the pixel electrode. The pixel particles are each positively or negatively charged. Furthermore, the pixel element 154 contains a dispersion medium in which the pixel particles are dispersed so as to be suspended. Here, when a predetermined voltage is applied between the common electrode and the pixel electrode and an electric field is thereby generated, the pixel particles suspended in the dispersion medium migrate in accordance their charge. As a result, the color, that is the display state, of the pixel element 154 can be made to change as viewed from the visible surface of the electro-optical apparatus.

### Transistor 152

The gate electrode of the transistor 152 is connected to a scanning line 112 and the source electrode of the transistor 152 is connected to a data line 122. Furthermore, a semiconductor region of the transistor 152 is formed from an organic semiconductor material and the transistor 152 is a p-type organic transistor. In addition, the drain electrode of the transistor 152 is connected to the pixel electrode of the pixel element 154. The polarization state of a gate-insulating layer can be changed in accordance with a voltage being applied from the scanning line 112 and the data line 122 connected to the transistor 152 and the polarization state is maintained even when application of the voltage ceases. Consequently, the switching characteristic of the transistor 152 has hysteresis. The configuration and characteristics of the transistor 152 will be described more concretely below.

### Scanning-Line Driving Circuit 110

As illustrated in FIG. 1, the scanning-line driving circuit 110 applies voltages to the gate electrodes of transistors 152a to 152i respectively included in pixels 150a to 150i via the corresponding scanning lines 112a to 112c. More specifically, a voltage is applied to the transistors 152a, 152b and 152c though the scanning line 112a, a voltage is applied to the transistors 152d, 152e and 152f through the scanning line 112b, and a voltage is applied to the transistors 152g, 152h and 152i through the scanning line 112c.

### Data-Line Driving Circuit 120

The data-line driving circuit 120 applies voltages to the source electrodes of the transistors 152a to 152i through the data lines 122a to 122c. More specifically, a voltage is applied to the transistors 152a, 152d and 152g through the data line 122a, a voltage is applied to the transistors 152b, 152e and 152h through the data line 122b, and a voltage is applied to the transistors 152c, 152f and 152i through the data line 122c.

### Common-Electrode Driving Circuit 130

The common electrode driving circuit 130 applies a common voltage to the common electrode, part of which is included in each of the pixels 150a to 150i, through the common electrode wiring 132.

In the electro-optical apparatus according to this embodiment, a single common electrode is provided, which is formed so as to extend to all the pixels included in the electro-optical apparatus and each of the pixels is configured so as to include part of the common electrode therein.

### Control Circuit 140

The control circuit 140 is configured so as to provide instructions relating to voltages to be applied to the individual pixels 150 to the scanning-line driving circuit 110, the data-line driving circuit 120 and the common-electrode driving circuit 130 in order to cause the electro-optical apparatus to perform predetermined display.

### 2-2. Example Configuration and Characteristics of Transistor Included in Electro-Optical Apparatus

An on state or an off state as a conduction state of the transistor 152 included in the electro-optical apparatus according to this embodiment is selected in accordance with a voltage that is applied from the scanning line 112 and the data line 122. Furthermore, as described above, the polarization state of the transistor 152 can be changed in accordance with the voltage applied from the scanning line 112 and the data line 122 and the switching characteristic of the transistor has hysteresis. Consequently, even when application of the voltage from the scanning line 112 and the data line 122 ceases, the selected conduction state of the transistor 152 is maintained. Here, an example configuration and characteristics of the transistor 152 will be concretely described.

### First Example Configuration of Transistor

FIG. 3 is a diagram illustrating a first example configuration of a transistor having hysteresis. As illustrated in FIG. 3, the transistor 152 is configured to include a substrate 200, a drain electrode 202, a source electrode 204, an organic semiconductor region 206, a ferroelectric layer 210 and a gate electrode 212. The drain electrode 202, the source electrode 204 and the organic semiconductor region 206 are formed on the substrate 200. The drain electrode 202 and the source electrode 204 are formed from a conductor material and the organic semiconductor region 206 is formed from an organic semiconductor material. Furthermore, the ferroelectric layer 210, which is formed from a ferroelectric material, is formed on the substrate 200 so as to cover the drain electrode 202, the source electrode 204 and the organic semiconductor region 206. The ferroelectric layer 210 also functions as a gate-insulating layer. The gate electrode 212 is formed on the ferroelectric layer 210 from a conductor material. In other words, the ferroelectric later 210 is formed so as to be sandwiched between the drain electrode 202, the source electrode 204 and the organic semiconductor region 206; and the gate electrode 212. With this configuration, when a voltage of a predetermined polarity is applied between the gate electrode 212 and the source electrode 204 or the drain electrode 202, the polarization of the ferroelectric layer 210 can be inverted. The ferroelectric layer 210 has two polarization directions that correspond to the polarities of the voltage applied between the gate electrode 212 and the source electrode 204 and the polarization direction is maintained even when application of a voltage ceases. In this specification, a first polarization direction corresponds to a first polarization state and a second polarization direction corresponds to a second polarization state. Here, saying that the polarization direction of the ferroelectric layer 210 changes is the same as saying the polarization state of the transistor 152 changes.

### Characteristics of Transistor

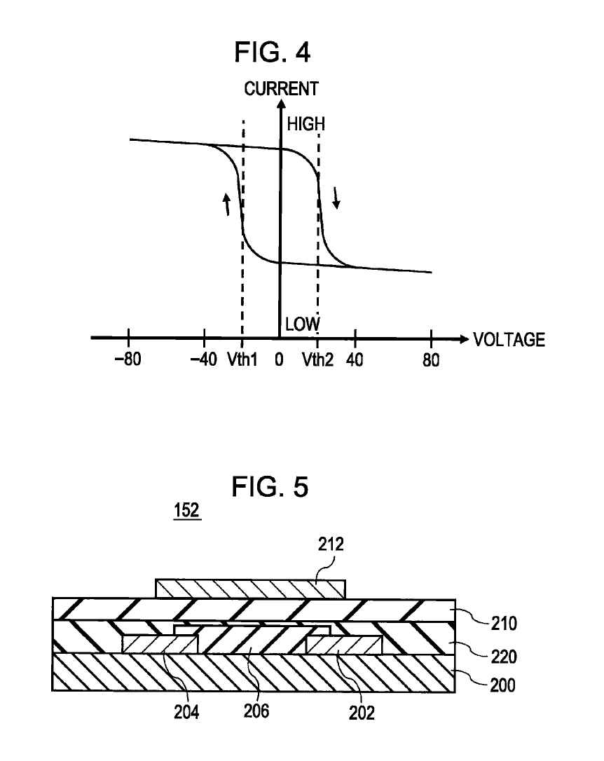

FIG. 4 is a diagram illustrating the voltage-current characteristics of the transistor 152 having hysteresis. In FIG. 4, the horizontal axis shows a gate-source voltage applied to the gate electrode 212 with the source electrode 204 of the transistor 152 serving as a base and the vertical axis shows a source-drain current that flows from the source electrode 204 of the transistor 152 to the drain electrode 202 of the transistor 152.

Here, when the gate-source voltage is made to be higher than a second threshold voltage Vth2, the polarization state of the ferroelectric layer 210 changes to the first polarization state. That is, the transistor 152 transitions to the first polarization state. Next, when the gate-source voltage is made to be lower than a first threshold voltage Vth1, the polarization state of the ferroelectric layer 210 changes to the second polarization state. That is, the transistor 152 transitions to the second polarization state. The transistor 152 is in an off state when in the first polarization state and is in an on state when in the second polarization state.

In the case where the transistor 152 is in the first polarization state, when the gate-source voltage becomes lower than the first threshold voltage Vth1, the transistor 152 transitions to the on state and a current flows therethrough, whereas when the gate-source voltage is higher than the first threshold voltage Vth1, the transistor 152 remains in the off state and no current flows therethrough. That is, the threshold voltage of the transistor 152 in the first polarization state is the first threshold voltage Vth1, which is lower than zero.

On the other hand, in the case where the transistor 152 is in the second polarization state, when the gate-source voltage becomes higher than the second threshold voltage Vth2, the transistor 152 transitions to the off state and no current flows therethrough, whereas when the gate-source voltage is lower than the second threshold voltage Vth2, the transistor 152 remains in the on state and a current flows therethrough. That is, the threshold voltage of the transistor 152 in the second polarization state is the second threshold voltage Vth2, which is higher than the first threshold voltage Vth1 and higher than zero.

In other words, in the case where the gate-source voltage is 0 V, when in the first polarization state, the transistor 152 is in the off state, whereas, when in the second polarization state, the transistor 152 is in the on state.

### Second Example Configuration of Transistor

FIG. 5 is a diagram illustrating a second example configuration of a transistor having hysteresis. As illustrated in FIG. 5, the transistor 152 has the first example configuration of a transistor illustrated in FIG. 3, but is configured to additionally include an insulating layer 220. That is, the insulating layer 220 is formed from an insulator on the substrate 200 so as to cover the drain electrode 202, the source electrode 204 and the organic semiconductor region 206. Then, the ferroelectric layer 210 is formed on the insulating layer 220. Here, the insulating layer 220 and the ferroelectric layer 210 both function as gate-insulating layers. As long as the ferroelectric layer 210 is also formed so as to be sandwiched between the source electrode and the drain electrode, and the gate electrode 212 in this configuration, a transistor having hysteresis can be formed, similarly to the transistor illustrated in FIG. 3. However, to ensure the transistor 152 has sufficient hysteresis, it is preferable to entirely construct the layers between the drain electrode 202, the source electrode 204 and the organic semiconductor region 206, and the gate electrode 212 from a ferroelectric material.

### 2-3. Example Operation of Electro-Optical Apparatus

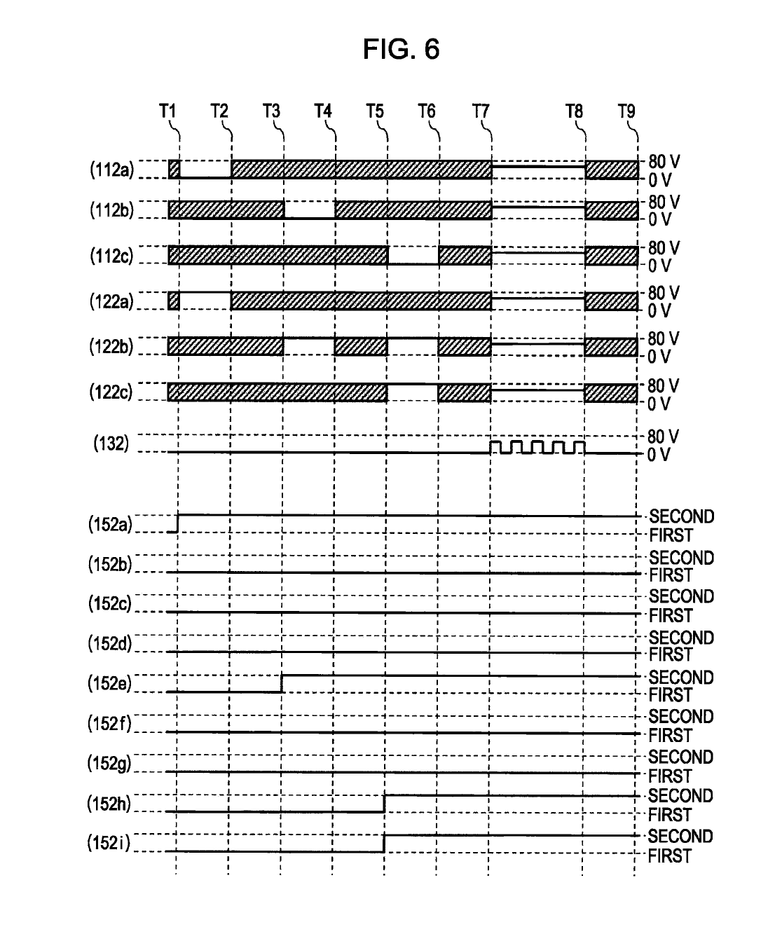

Next, operation of the electro-optical apparatus according to this embodiment will be concretely described while referring to FIGS. 6 to 13.

FIG. 6 is a diagram illustrating the changes with time of voltages applied to the individual lines and the changes with time of the polarization states of the transistors 152 when the display state of the electro-optical apparatus is changed. In FIG. 6, the changes with time of the voltages applied to the scanning lines 112a, 112b and 112c, to the data lines 122a, 122b, and 122c, and to the common electrode wiring 132 are illustrated in this order from the top. Therebelow in FIG. 6, the changes with time of the respective polarization states of the transistors 152a to 152i are illustrated. The polarization states are each illustrated as being either the first polarization state or the second polarization state. In the following explanation, it is assumed that the transistors 152a to 152i are all initially in the first polarization state.

### (1) Changes of Polarization States of Transistors

### From Time T1 to Time T2

As illustrated in FIG. 6, during the period from time T1 to time T2, the scanning-line driving circuit 110 applies a first voltage V1 of for example 0 V to the scanning line 112a from among the scanning lines 112a to 112c and puts the scanning lines 112b and 112c into a high-impedance state. During this period, the scanning line 112a is in a selected state and the scanning lines 112b and 112c are each in a non-selected state. Simultaneously with this, the data-line driving circuit 120 applies a second voltage V2 of for example 80V to the data line 122a from among the data lines 122a to 122c and puts the data lines 122b and 122c into a high-impedance state. During this period, the voltage applied to the common electrode wiring 132 continues to be 0 V. As a result of applying voltages in this way, the transistor 152a transitions to the second polarization state from the first polarization state and the other transistors including the transistors 152b and 152c continue to maintain the first polarization state.

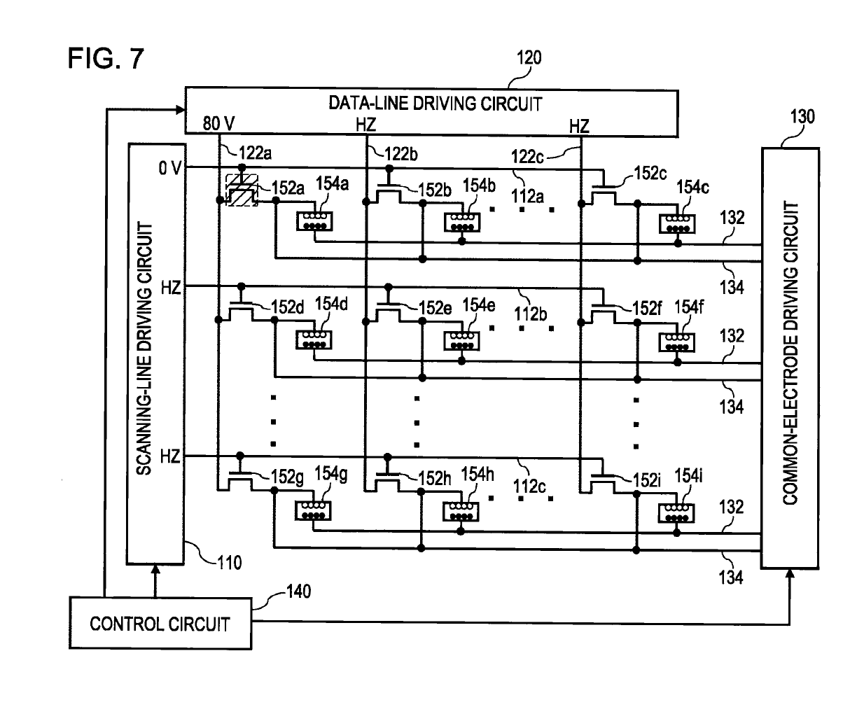

FIG. 7 is a diagram illustrating the state of the electro-optical apparatus at time T2. As illustrated in FIG. 7, the transistor 152a has a voltage of 0 V being applied to the gate electrode thereof, a voltage of 80 V being applied to the source electrode thereof, giving a gate-source voltage of −80 V, and the transistor 152a is in the second polarization state. Furthermore, the other transistors 152b to 152i, in each of which at least one of the gate electrode and the source electrode is in a high-impedance state, continue to maintain the same polarization state as before.

In FIGS. 7 to 10 and FIGS. 12 and 13, the transistors among the transistors 152a to 152i that are shaded with diagonal lines are in the second polarization state, whereas those not shaded with diagonal lines are in the first polarization state.

### From Time T3 to Time T4

Next, as illustrated in FIG. 6, during the period from time T3 to time T4, the scanning line driving circuit 110 applies a voltage of 0 V to the scanning line 112b from among the scanning lines 112a to 112c and puts the scanning lines 112a and 112c into a high-impedance state. Simultaneously with this, the data-line driving circuit 120 applies a voltage of 80 V to the data line 122b from among the data lines 122a to 122c and puts the data lines 122a and 122c into a high-impedance state. During this period, the voltage applied to the common electrode wiring 132 continues to be 0 V. As a result of applying voltages in this way, the transistor 152e transitions to the second polarization state from the first polarization state and the other transistors including the transistors 152d and 152f continue to maintain the same polarization state as before.

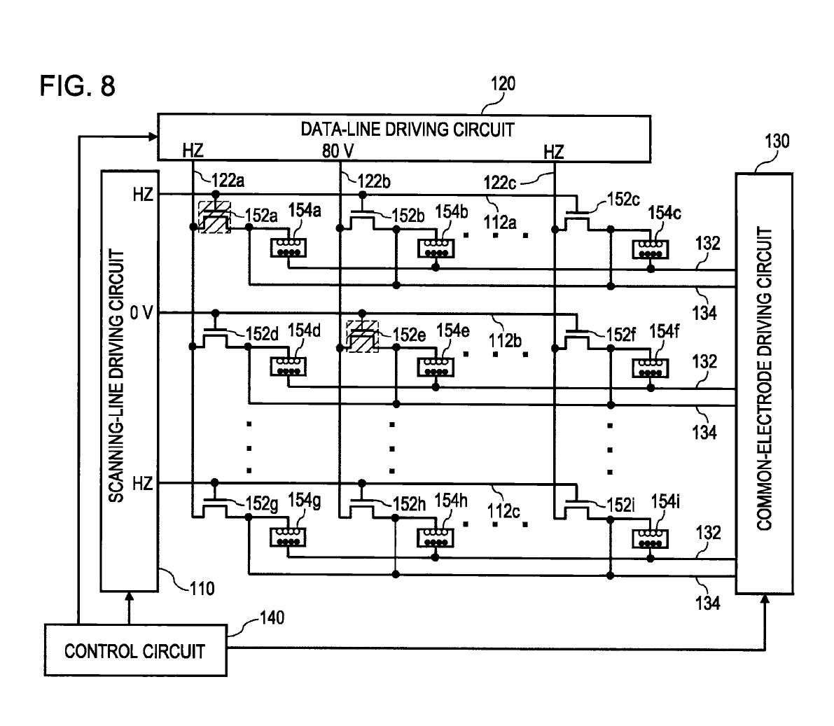

FIG. 8 is a diagram illustrating the state of the electro-optical apparatus at time T4. As illustrated in FIG. 8, the transistor 152e has a voltage of 0 V being applied to the gate electrode thereof, a voltage of 80 V being applied to the source electrode thereof, giving a gate-source voltage of −80 V, and the transistor 152e is in the second polarization state. Furthermore, the other transistors 152a to 152d and 152f to 152i, in each of which at least one of the gate electrode and the source electrode is in a high-impedance state, continue to maintain the same polarization state as before.

From time T5 to time T6

Next, as illustrated in FIG. 6, during the period from time T5 to time T6, the scanning-line driving circuit 110 applies a voltage of 0 V to the scanning line 112c from among the scanning lines 112a to 112c and puts the scanning lines 112a and 112b into a high-impedance state. Simultaneously with this, the data-line driving circuit 120 applies a voltage of 80 V to the data lines 122b and 122c from among the data lines 122a to 122c and puts the data line 122a into a high-impedance state. During this period, the voltage that is applied to the common electrode wiring 132 continues to be 0 V. By applying voltages in this way, the transistors 152h and 152i are made to transition to the second polarization state from the first polarization state, whereas the other transistors including the transistor 152g continue to maintain the same polarization state as before.

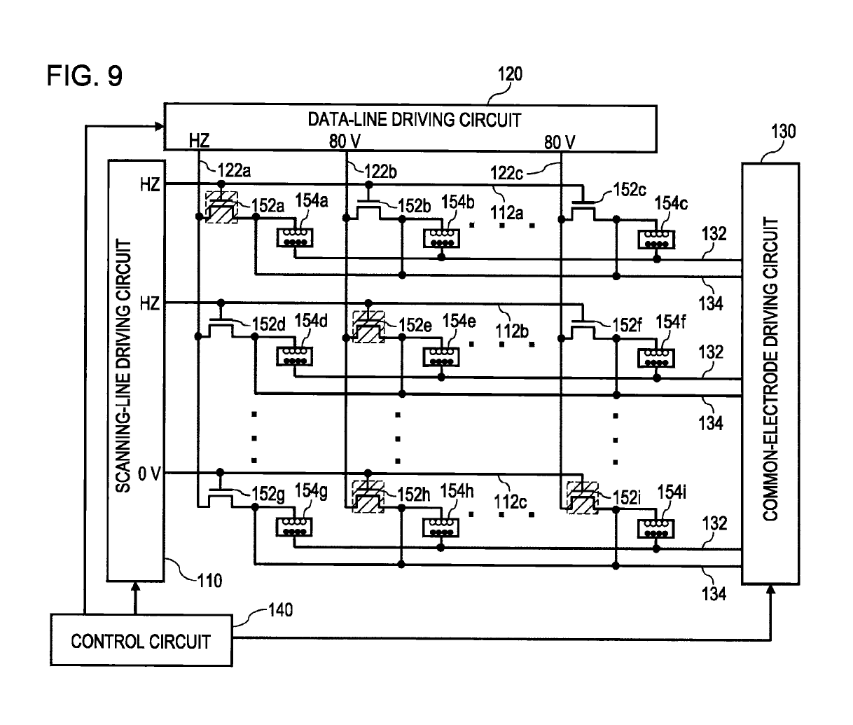

FIG. 9 is a diagram illustrating the state of the electro-optical apparatus at time T6. As illustrated in FIG. 9, the transistors 152h and 152i each have a voltage of 0 V being applied to the gate electrode thereof, a voltage of 80 V being applied to the source electrode thereof, giving a gate-source voltage of −80 V and the transistors 152h and 152i are each in the second polarization state. Furthermore, the other transistors 152a to 152g, in each of which at least one of the gate electrode and the source electrode is in a high-impedance state, continue to maintain the same polarization state as before.

### (2) Change of Display State

### From Time T7 to Time T8

Next, as illustrated in FIG. 6, during the period from time T7 to time T8, the scanning-line driving circuit 110 applies a voltage V3, which is between 0 V and 80 V, of for example 40V to all of the scanning lines 112a to 112c. The data-line driving circuit 120 applies a voltage of 40 V, which is a voltage between 0 V and 80 V, to all of the data lines 122a to 122c. Furthermore, the common-electrode driving circuit 130 applies a voltage having a rectangular waveform that periodically changes between 0 V and 40 V to the common electrode wiring 132, as illustrated in FIG. 6.

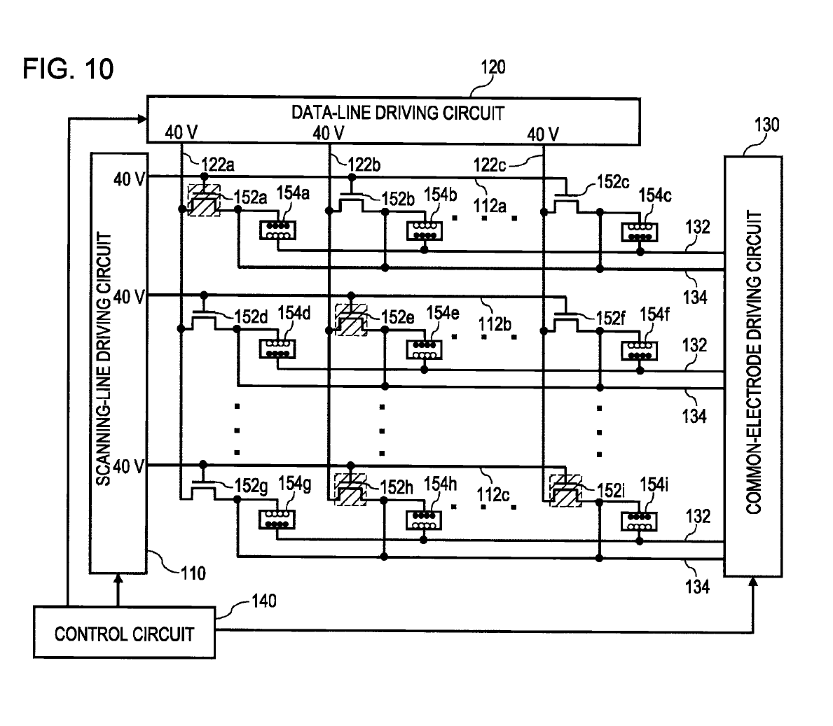

FIG. 10 is a diagram illustrating the state of the electro-optical apparatus at time T8. As described above, when a voltage of 40 V is applied from the scanning lines 112a to 112c and from the data lines 122a to 122c, the gate-source voltage of the transistors 152a to 152i becomes 0 V. Then, since the transistors 152b, 152c, 152d, 152f and 152g are in the first polarization state and the threshold voltage is Vth1, which is lower than zero, the transistors are in the off state. On the other hand, since the transistors 152a, 152e, 152h and 152i are in the second polarization state and the threshold voltage is Vth2, which is higher than 0 V, the transistors are in the on state. Then, the voltage applied to the pixel electrodes of the pixel elements 154a, 154e, 154h and 154i, which are connected to the transistors in the on state, becomes 40 V. On the other hand, no voltage is applied to the pixel electrodes of the pixel elements 154b, 154c, 154d, 154f and 154g, which are connected to the transistors in the off state, and they are in a high-impedance state.

Here, as illustrated in FIG. 6, the common-electrode driving circuit 130 applies a voltage having a rectangular waveform that periodically changes between 0 V and 40 V to the common electrode wiring 132 during the period from time T7 to time T8, and therefore a voltage having a rectangular waveform that periodically changes between 0 V and 40 V is applied to the common electrode serving as a base of the pixel elements 154a, 154e, 154h and 154i. Thus, by applying voltages between the pixel electrodes and the common electrode in this way, the display states of the pixel elements 154a, 154e, 154h and 154i can be changed from a white display state, which is a first display state, to a black display state, which is a second display state.

Summary of Operation of Electro-Optical Apparatus from Time T1 to Time T8

In the electro-optical apparatus configured as described above, the voltages that the scanning-line driving circuit 110 and the data-line driving circuit 120 respectively apply to a first transistor 152 through a first scanning line 112 and a first data line 122 are changed to predetermined voltages. With this, the polarization state of the first transistor 152 is changed from the first polarization state to the second polarization state. Next, the scanning-line driving circuit 110 and the data-line driving circuit 120 similarly cause a second transistor 152 connected to a second scanning line 112, which is different from the first scanning line 112, and the first data line 122 to change to the second polarization state from the first polarization state. Then, the scanning-line driving circuit 110 and the data-line driving circuit 120 respectively change the voltages being applied to the first transistor 152 and the second transistor 152 through the first and second scanning lines 112 and the first data line 122 to predetermined voltages and the common-electrode driving circuit 130 applies a predetermined voltage to the common electrode, so as to simultaneously change the display states of a first pixel 150 including the first transistor 152 and a second pixel 150 including the second transistor 152.

Here, in order to change the polarization state of the transistor 152, a time on the order of for example several microseconds is needed. Thus, assuming that for example there are one thousand scanning lines 112, a time on the order of several milliseconds is necessary to change the polarization states of all of the transistors 152. Furthermore, in order to change the display state of the pixel element 154 included in the pixel 150, it is necessary to apply a voltage that periodically changes between 0 V and 40 V with a period on the order of several tens of to several hundred milliseconds between the pixel electrode and the common electrode of the pixel element 154. Changing of the display states of all the pixel elements 154 can be performed simultaneously for all the pixel elements 154 in the above-described way. Therefore, a time on the order of (several tens of to several hundred milliseconds)+(several milliseconds) is necessary to change the display state of the entire electro-optical apparatus.

In contrast, in electro-optical apparatuses of the related art, a method has been used in which the display states of a plurality of pixels formed on the same scanning line are changed and then the display states of a plurality of pixels formed on the next scanning line are changed, and so on. Here, in order to change the display states of all the pixels on a single scanning line, a time on the order of for example several milliseconds is needed. Therefore, a time on the order of (several milliseconds)×(number of scanning lines) has been needed to change the display states of all of the pixels of the electro-optical apparatus. This time is for example on the order of several seconds in the case where the electro-optical apparatus includes one thousand scanning lines.

Accordingly, with the electro-optical apparatus having the above-described configuration and the method of driving the electro-optical apparatus according to this embodiment, the time required to change the display state of pixels included in the electro-optical apparatus can be shortened. This provides an advantage that the number of scanning lines can be greatly increased.

In addition, with the electro-optical apparatus and the method of driving the electro-optical apparatus according to this embodiment, when the display states of the pixels 150 are changed, the common-electrode driving circuit 130 periodically changes the voltage applied to the common electrode between the first voltage of 0 V and the second voltage of 40 V. Therefore, the pixel particles can be made to move while being subjected to electrical oscillation, due to the fact that the voltage applied between the common electrode and the pixel electrodes is periodically changed when the display state of the pixels 150 is being changed. Consequently, the pixel particles can be made to move while remaining in a moderately dispersed state and the contrast ratio of display can be increased.

Furthermore, with the electro-optical apparatus and the method of driving the electro-optical apparatus according to this embodiment, the gate-source voltage of a transistor 152 being changed from the first polarization state to the second polarization state is −80 V. On the other hand, at least one of the gate electrode and the source electrode of a transistor 152 made to maintain the first polarization state is put into a high-impedance state as a result of either the scanning line 112 or the data line 122 connected thereto being put into a high-impedance state.

With the electro-optical apparatus and the method of driving the electro-optical apparatus according to this embodiment, the polarization state of a transistor 152 that is to maintain the same polarization state can be prevented from being suddenly changed due to the effect of a surge occurring in the applied voltage.

### (3) Resetting of Display State

### From Time T11 to Time T12

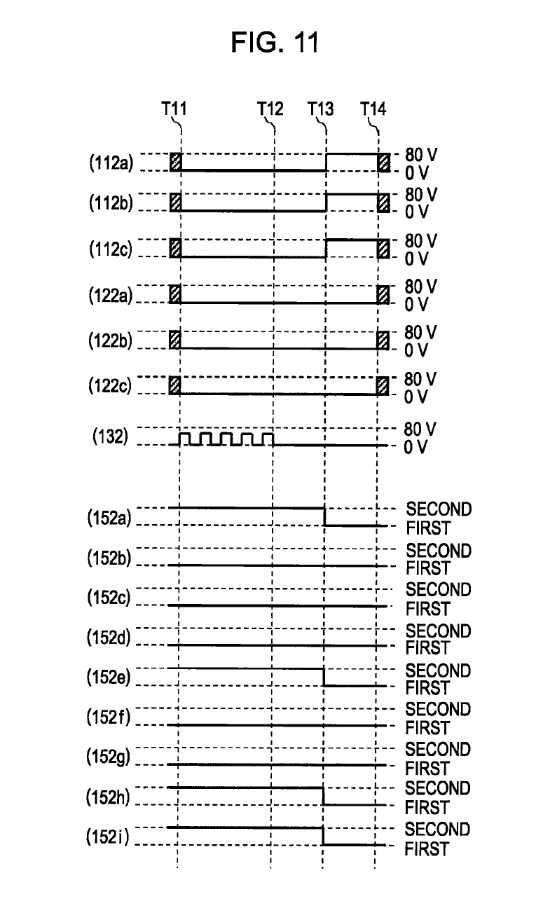

FIG. 11 is a diagram illustrating the changes with time of the voltages applied to the individual lines and the changes with time of the polarization states of the transistors when the polarization states of all of the transistors and the display state of the electro-optical apparatus are reset. In this embodiment, resetting the display state of the electro-optical apparatus refers to changing from a state in which some of the pixels 150 among the plurality of pixels 150 of the electro-optical apparatus display black to a state in which all of the pixels 150 display white. In addition, resetting the polarization state of each of the transistors of the electro-optical apparatus refers to changing all of the transistors 152 to the first polarization state.

As illustrated in FIG. 11, during the period from time T11 to time T12, the scanning-line driving circuit 110 applies a voltage of 0 V to all of the scanning lines 112a to 112c. In addition, the data-line driving circuit 120 applies a voltage of 0 V to all of the data lines 122a to 122c. Furthermore, the common-electrode driving circuit 130 applies a voltage having a rectangular waveform that periodically changes between 0 V and 40 V to the common electrode wiring 132, as illustrated in FIG. 11.

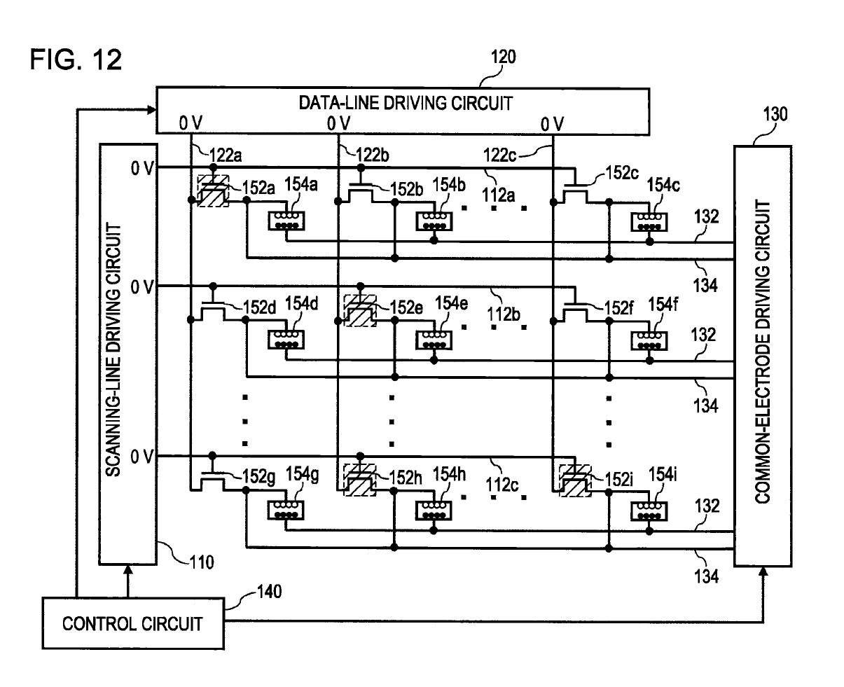

FIG. 12 is a diagram illustrating the state of the electro-optical apparatus at time T12. When a voltage of 0 V is applied to the scanning lines 112a to 112c and to the data lines 122a to 122c as described above, the gate-source voltage of the transistors 152a to 152i becomes 0 V. Then, since the transistors 152b, 152c, 152d, 152f and 152g are in the first polarization state and the threshold voltage is Vth1, which is less than 0 V, the transistors are in the off state. On the other hand, since the transistors 152a, 152e, 152h and 152i are in the second polarization state and the threshold voltage is Vth2, which is higher than 0 V, the transistors are in the on state. Then, the voltage applied to the pixel electrodes of the pixel elements 154a, 154e, 154h and 154i, which are connected to transistors that are in the on state, is 0 V. In contrast, no voltage is applied to the pixel electrodes of the pixel elements 154b, 154c, 154d, 154f and 154g connected to transistors that are in the off state and they are in a high-impedance state.

Here, as illustrated in FIG. 11, during the period from time T11 to time T12, the common-electrode driving circuit 130 applies a voltage having a rectangular waveform that periodically changes between 0 V and 40 V to the common electrode wiring 132 and therefore the voltage that is applied to the common electrode serving as a base of the pixel electrodes of the pixel elements 154a, 154e, 154h and 154i becomes a voltage having a rectangular waveform that periodically changes between 0 V and 40 V. By applying such a voltage between the pixel electrodes and the common electrode, the display states of the pixel elements 154a, 154e, 154h and 154i can be changed from a black display state, which is the second display state, to a white display state, which is the first display state. Consequently, the display states of all of the pixel elements 154a to 154i of the electro-optical apparatus can be changed to the white display state, which is the first display state.

### (4) Resetting of Polarization States of Transistors

From time T13 to time T14

Next, as illustrated in FIG. 11, during the period from time T13 to time T14, the scanning-line driving circuit 110 applies a voltage of 80 V to the scanning lines 112a to 112c and simultaneously the data-line driving circuit 120 applies a voltage of 0 V to the data lines 122a to 122c. During this period, the voltage applied to the common electrode wiring 132 continues to be 0 V. By applying these voltages, voltages are applied for changing the polarization states of all of the transistors 152a to 152i to the first polarization state. However, since the transistors 152b, 152c, 152d, 152f and 152g are already in the first polarization state by time T13, in reality, only the transistors 152a, 152e, 152h and 152i are changed from the second polarization state to the first polarization state.

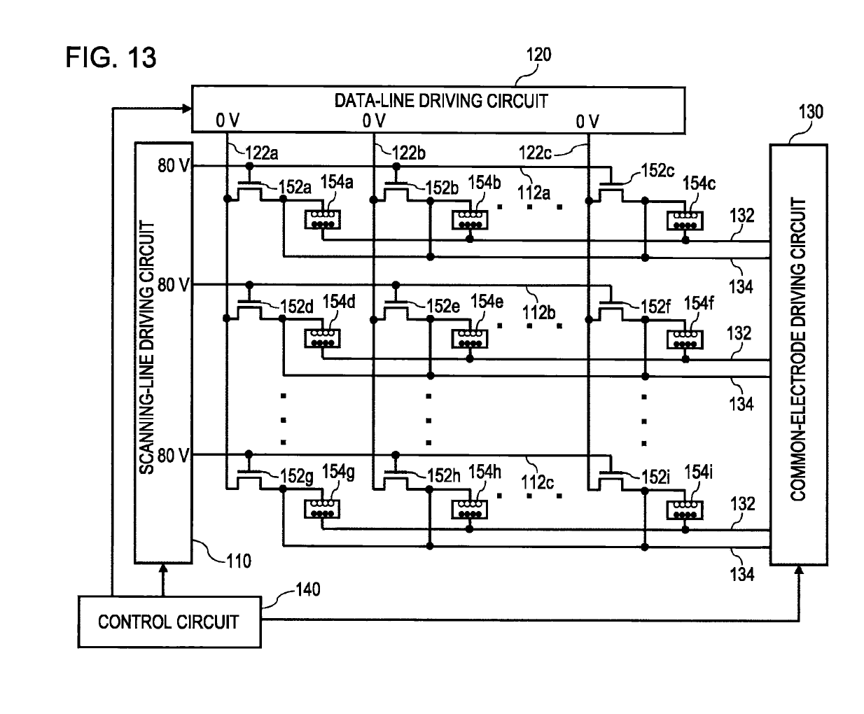

FIG. 13 is a diagram illustrating the state of the electro-optical apparatus at time T14. As illustrated in FIG. 13, for all of the transistors 152a to 152i, a voltage of 80 V is applied to the gate electrode and a voltage of 0 V is applied to the source electrode, giving a gate-source voltage of 80 V. Consequently, all of the transistors 152a to 152i are in the first polarization state.

Summary of Operation of Electro-Optical Apparatus During Period from Time T11 to Time T14

In the electro-optical apparatus according to this embodiment, as described above, the voltages applied to the scanning lines 112 and the data lines 122 can be changed to predetermined voltages, whereby the display state of the electro-optical apparatus can be changed to the first display state and the polarization states of the transistors 152 can be changed to the first polarization state in a short period of time.

### Summary of Voltages Applied to Pixels 150 and Changes of State

As is clear from the description of this embodiment, the pixels 150 perform the following operations in accordance with voltages applied from the scanning lines 112 and the data lines 122 connected thereto. Hereafter, a single scanning line 112, data line 122, pixel 150 and transistor 152 will be referred to for convenience.

First, provided that either the scanning line 112 or the data line 122 is in a high impedance state, the polarization state of the transistor 152 does not change and the transistor 152 remains in the first polarization state, i.e., the off state, and therefore the display state of the pixel 150 also does not change. Second, when a voltage of 0 V is applied to the scanning line 112 and a voltage of 80 V is applied to the data line 122, the polarization state of the transistor 152 is changed from the first polarization state to the second polarization state, i.e., the on state. Third, when a voltage of 80 V is applied to the scanning line 112 and a voltage of 0 V is applied to the data line 122, the polarization state of the transistor 152 is changed from the second polarization state to the first polarization state. Fourth, when a voltage of 0 V is applied to both the scanning line 112 and the data line 122, if the transistor 152 is in the second polarization state, i.e., the on state, a voltage of 0 V is applied to the pixel electrode of the pixel element 154. At this time, the display state of the pixel element 154 can be changed in accordance with the voltage applied to the common electrode of the pixel element 154. In addition, if the transistor 152 is in the first polarization state, i.e., the off state, no voltage is applied to the pixel electrode of the pixel element 154 and the pixel electrode is in a high-impedance state. Fifth, when a voltage of 40 V is applied to both the scanning line 112 and the data line 122, if the transistor 152 is in the second polarization state, i.e., the on state, a voltage of 40 V is applied to the pixel electrode of the pixel element 154. At this time, the display state of the pixel element 154 can be changed in accordance with the voltage applied to the common electrode of the pixel element 154. In addition, if the transistor 152 is in the first polarization state, i.e., the off state, no voltage is applied to the pixel electrode of the pixel element 154 and the pixel electrode is in a high-impedance state.

To date, transistors that do not have hysteresis have been used but when using such transistors, it has been necessary to provide a capacitor connected in parallel with the pixel element in order to increase the speed with which the display is refreshed. However, according to this embodiment of the invention, the display can be refreshed at a high speed even when no capacitor is provided and therefore it is not necessary to provide a capacitor and an advantage that the manufacturing process can be simplified is obtained. Furthermore, since there is no need for a capacitor, there is an advantage that the degree of freedom with which the pixel element 154 and the transistor 152 are arranged is increased.

### 3. Second Embodiment

In the first embodiment, an example was described in which, during the period from time T13 to time T14, the polarization states of all of the transistors 152a to 152i are reset to the first polarization state, i.e., the off state. However, in this embodiment, an example will be described in which, during the period from time T13 to time T14, the polarization states of all of the transistors 152a to 152i are reset to the second polarization state, i.e., the on state. Since the second embodiment differs from the first embodiment in terms of the reset state of the transistors 152a to 152i, this point of difference will be focused on in the following description.

First, the pixel elements 154a to 154i are in a black display state, which is the second display state, and it is assumed that all of the transistors 152a to 152i have been reset to the second polarization state.

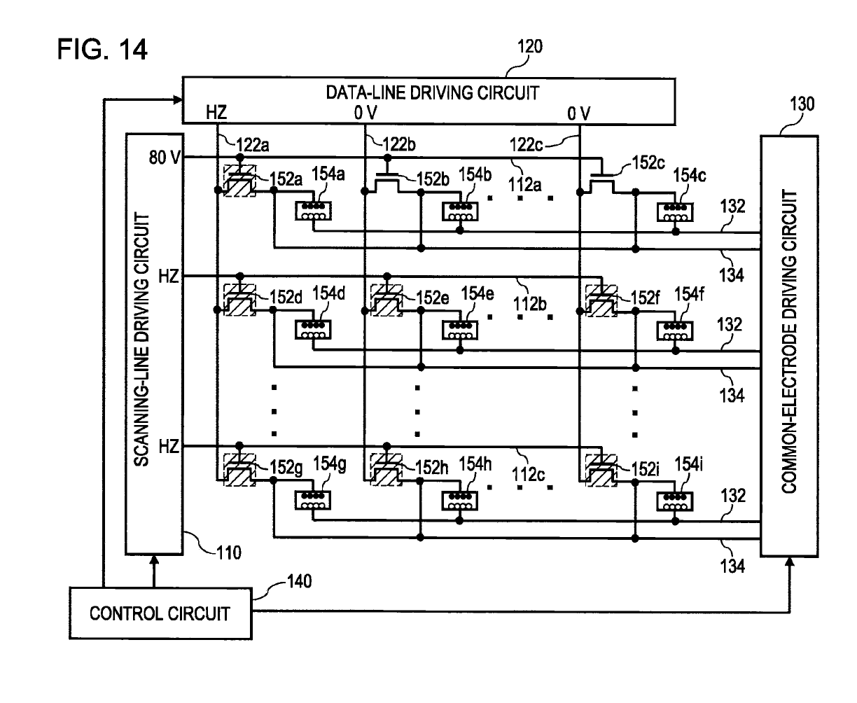

Next, as illustrated in FIG. 14, a voltage of 80 V is applied to the scanning line 112a, and the scanning line 112b and the scanning line 112c are put into a high-impedance state. In addition, a voltage of 0 V is applied to the data line 122b and the data line 122c, and the data line 122a is put into a high-impedance state. By applying voltages in this way, the polarization state of the transistor 152b and the polarization state of the transistor 152c are changed from the second polarization state to the first polarization state and the transistor 152a maintains the second polarization state. Next, similarly to in the first embodiment, the other scanning lines 112b and 112c are selected in order and the polarization states of the other transistors 152d to 152i are selectively changed from the second polarization state to the first polarization state.

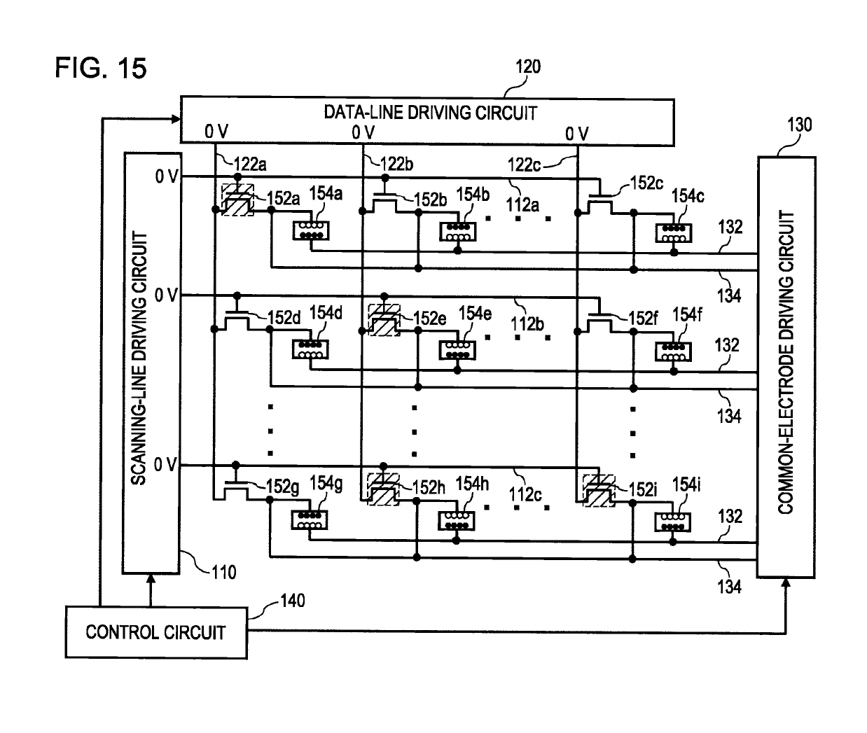

Next, as illustrated in FIG. 15, the scanning-line driving circuit 110 applies a voltage of 0 V to all of the scanning lines 112a to 112c and the data-line driving circuit 120 applies a voltage of 0 V to all of the data lines 122a to 122c. Furthermore, the common-electrode driving circuit 130 applies a voltage having a rectangular waveform that periodically changes between 0 V and 40 V to the common electrode wiring 132, similarly to as illustrated in FIG. 6. By applying voltages in this way, only the pixels 150 whose transistors are in the on state are changed from the second display state to the first display state, which is the white display state.

In order to reset the display state of all of the pixel elements 154a to 154i to the black display state, which is the second display state, a voltage of for example 40V as an intermediate voltage V3 that is between 0 V and 80 V is applied to all of the scanning lines 112a to 112c and the data lines 122a to 122c, and a voltage having a rectangular waveform that periodically changes between 0 V and 40 V is applied to the common electrode wiring 132, similarly to as illustrated in FIG. 6. Accordingly, the pixel elements 154 whose transistors are in the on state are changed to the black display state, which is the second display state.

In order to reset all of the transistors 152a to 152i to the second polarization state, a voltage of 0 V is applied to the scanning lines 112a to 112c, a voltage of 80 V is applied to the data lines 122a to 122c and a voltage of 80 V is applied to the common electrode wiring 132.

The same advantages are obtained with this embodiment as with the first embodiment.

4. Examples of Electronic Appliances Equipped with the Electro-Optical Apparatus

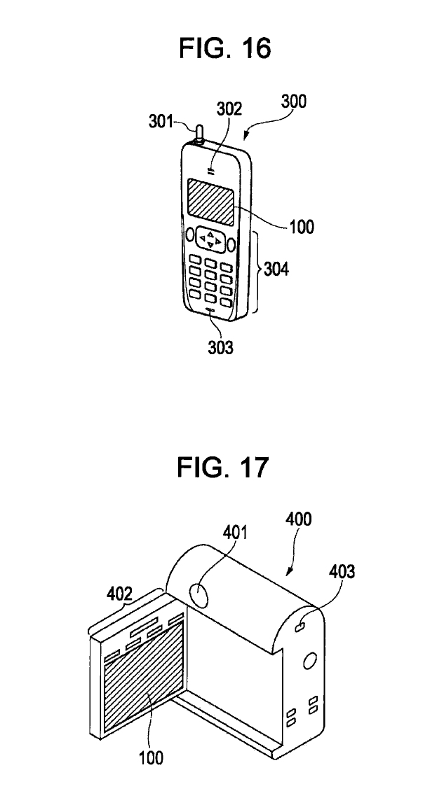

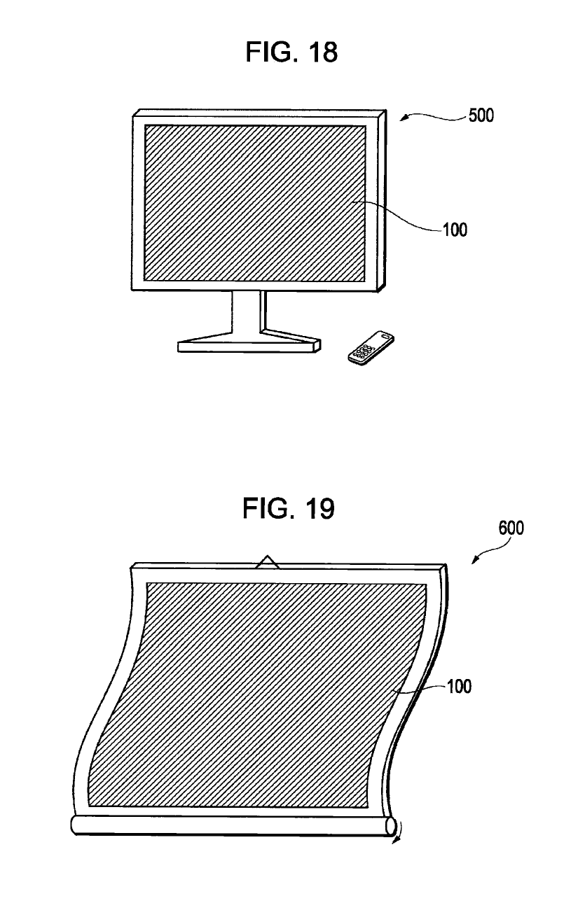

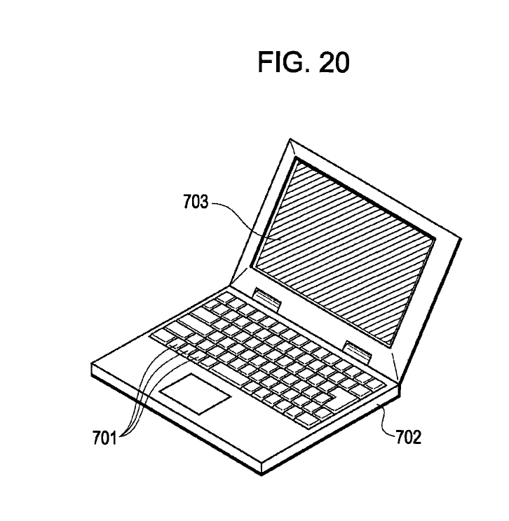

Next, specific examples of electronic appliances equipped with an electro-optical apparatus 100 will be described while referring to FIGS. 16 to 20. FIG. 16 illustrates an example in which the electro-optical apparatus 100 is applied to a mobile phone. A mobile phone 300 is equipped with an antenna 301, a speech output unit 302, a speech input unit 303, an operation unit 304 and the electro-optical apparatus 100. FIG. 17 illustrates an example in which the electro-optical apparatus 100 is applied to a video camera. A video camera 400 is equipped with an image-receiving unit 401, an operation unit 402, an audio input unit 403 and the electro-optical apparatus 100. FIG. 18 illustrates an example in which the electro-optical apparatus 100 is applied to a television. A television 500 is equipped with the electro-optical apparatus 100. FIG. 19 illustrates an example in which the electro-optical apparatus 100 is applied to a roll-up-type television. A roll-up-type television 600 is equipped with the electro-optical apparatus 100. FIG. 20 illustrates a personal computer. The personal computer is equipped with a main body 702 provided with a keyboard 701, and a display unit 703 that uses the electro-optical apparatus.

Not limited to the above-described examples, the electro-optical apparatus according to an embodiment of the invention can be for example applied to various types of electronic appliances having a display function. Examples other than those mentioned above include facsimile machines having a display function, the viewfinder of digital cameras, portable televisions, electronic organizers, video billboards and promotional displays.

With the electronic appliances having the above-described configurations, as a result of being given the characteristics of the electro-optical apparatus according to any of the embodiments of the invention, for example electronic appliances can be provided that are capable of changing the displays thereof in a short period of time.

### 5. Additional Information

In the above-described embodiments, the pixel particles included in the pixels 150 of the electro-optical apparatus were described as being of two colors of white and black as an example; however, the pixel particles may be of any arbitrary combination of colors or may be of just a single color.

Furthermore, in the above-described embodiments, as an example the pixels 150 included in the electro-optical apparatus were described as each including part of the common electrode therein; however, embodiments of the invention include not only embodiments where the common electrode is formed from a single conductor but also embodiments where a composite electrode formed of a plurality of conductors is used as the common electrode. In such a case, the composite formed from the plurality of conductors is sometimes referred to as a common electrode. However, from the viewpoint of for example minimizing manufacturing cost, it is preferable to form the common electrode from a single conductor.

In addition, in the above-described embodiments, voltages of 80 V, 40 V and 0 V are used during operations, but embodiments of the invention are not limited to using these voltages. In other words, the fact that suitable voltages are to be selected in accordance with the characteristics of the transistors 152 should be obvious to those skilled in the art from the above description.

However, if the voltage applied to the pixel elements is too high, there is a danger that the reliability of the pixel elements 154 will be reduced due to for example electrolysis, conductor migration or adsorption of ions. Accordingly, although in the case where the polarization state of the transistors 152 is to be changed, a voltage that is sufficiently higher than the threshold of polarization inversion of the ferroelectric layer 210 is applied to the ferroelectric layer 210, in the case where the display state of the pixel elements 154 is to be changed, it is preferable that a voltage applied to the pixel elements 154 be made as low as possible.

In addition, in the above-described embodiments, as an example, it was described that the common-electrode driving circuit 130 applies a voltage having a rectangular waveform that periodically changes between 0 V and 40 V to the common electrode wiring 132 when the display states of the pixels 150 are being changed, but embodiments of the invention are not limited to this. For example, it is preferable that the voltage that the common-electrode driving circuit 130 applies to the common electrode wiring 132 not have a perfectly rectangular waveform but rather have a trapezoidal waveform that does not change suddenly when rising and falling. With this, the voltage of the drain electrode of the transistor 152 can be prevented from becoming lower than 0 V due to the voltage of the pixel electrode opposing the common electrode becoming lower than 0V. Furthermore, embodiments of invention include those in which the common-electrode driving circuit 130 switches between applying a first voltage and a second voltage to the common electrode wiring 132 at suitable intervals. Still furthermore, the common-electrode driving circuit 130 may apply a fixed potential of 0 V or 40 V to the common electrode wiring 132 when the display states of the pixel elements 154 are being changed. It is also possible to change the display state in these ways.

In addition, in the above-described embodiments, an example was described in which after the polarization states of the transistors 152 and the display states of the pixels 150 have been changed in the electro-optical apparatus, the display states of the pixels 150 are reset and the polarization states of the transistors 152 are reset. However, embodiments of the invention are not limited to this and only the display states of the pixels 150 may be reset or only the polarization states of the transistors 152 may be reset or any combination of the two may be adopted within the scope of the gist of the invention.

Furthermore, in the above-described embodiments, a specific example was described in which there are three scanning lines and three data lines, but the numbers of scanning lines and data lines can be decided upon as appropriate.

In addition, in the above-described embodiments, as for example illustrated in FIG. 7, when the polarization state of the transistor 152a is changed, the non-selected scanning lines 112b and 112c are put into a high-impedance state and the data lines 122b and 122c, which are connected to the transistors 152b and 152c whose polarization states do not need to be changed, are also put into a high-impedance state. However, as has already been described, provided that either the scanning line or the data line connected to a transistor is put into a high-impedance state, the polarization state of the transistor can be maintained without being changed.

Accordingly, a voltage of such a size that the polarization states of the transistors 152d and 152g are not changed, for example 80V, may be applied to the scanning lines 112b and 112c, instead of putting the scanning lines 112b and 112c into a high-impedance state while the data lines 122b and 122c are in a high-impedance state.

In addition, a voltage of such a size that the polarization states of the transistors 152b and 152c are not changed, for example 0 V, may be applied to the data lines 122b and 122c while the scanning lines 112b and 112c are put into a high-impedance state.

The entire disclosure of Japanese Patent Application No. 2009-169266, filed Jul. 17, 2009 is expressly incorporated by reference herein.

What is claimed is:

1. An electro-optical apparatus comprising:
a first pixel including a first transistor, a first pixel electrode and a first common electrode that opposes the first pixel electrode;
a second pixel including a second transistor, a second pixel electrode and a second common electrode that opposes the second pixel electrode;
a first scanning line that is electrically connected to the first transistor;
a second scanning line that is electrically connected to the second transistor;
a first data line that is electrically connected to the first transistor and the second transistor;
common electrode wiring that is electrically connected to the first common electrode and the second common electrode; and
a driving circuit that controls voltages applied to the first scanning line, the second scanning line, the first data line and the common electrode wiring;
wherein a switching characteristic of the first transistor and a switching characteristic of the second transistor have hysteresis;
wherein an on state or an off state is selected as a conduction state of the first transistor in accordance with a voltage applied between the first scanning line and the first data line;
wherein an on state or an off state is selected as a conduction state of the second transistor in accordance with a voltage applied between the second scanning line and the first data line; and
wherein the driving circuit is configured to be capable of selecting the on state or the off state as the conduction state of the first transistor, then selecting the on state or the off state as the conduction state of the second transistor, and then simultaneously changing the display state of the first pixel and the display state of the second pixel from a first display state to a second display state.

2. The electro-optical apparatus according to claim 1,
wherein the driving circuit is configured to be capable of controlling voltages that are applied to the first scanning line, the second scanning line, the first data line and the common electrode wiring so as to simultaneously change the display state of the first pixel and the display state of the second pixel from the second display state to the first display state and then change the conduction state of the first transistor and the conduction state of the second transistor to the on state or the off state.

3. The electro-optical apparatus according to claim 1,
wherein the first pixel further includes pixel particles that are provided between the first common electrode and the first pixel electrode;
wherein the second pixel further includes pixel particles that are provided between the second common electrode and the second pixel electrode; and
wherein the driving circuit is configured so as to periodically change the voltage applied between the first common electrode and the first pixel electrode and the voltage applied between the second common electrode and the second pixel electrode between a first voltage and a second voltage when simultaneously changing the display state of the first pixel and the display state of the second pixel from the first display state to the second display state.

4. An electronic appliance comprising:
the electro-optical apparatus according to claim 1.

5. A method of driving an electro-optical apparatus that includes a first pixel having a first transistor, a first pixel electrode and a first common electrode that opposes the first pixel electrode; a second pixel having a second transistor, a second pixel electrode and a second common electrode that opposes the second pixel electrode; a first scanning line that is electrically connected to the first transistor; a second scanning line that is electrically connected to the second transistor; a first data line that is electrically connected to the first transistor and the second transistor; common electrode wiring that is electrically connected to the first common electrode and the second common electrode; and a driving circuit that controls voltages applied to the first scanning line, the second scanning line, the first data line and the common electrode wiring; a switching characteristic of the first transistor and a switching characteristic of the second transistor having hysteresis;
the method comprising:
selecting an on state or an off state as a conduction state of the first transistor in accordance with a voltage applied between the first scanning line and the first data line;
selecting an on state or an off state as a conduction state of the second transistor in accordance with the voltage applied between the second scanning line and the first data line; and
controlling the voltages applied to the first scanning line, the second scanning line, the first data line and the common electrode wiring so as to simultaneously change the display state of the first pixel and a display state of the second pixel from a first display state to a second display state.

6. The method of driving the electro-optical apparatus according to claim 5 further comprising:
controlling voltages that are applied to the first scanning line, the second scanning line, the first data line and the common electrode wiring so as to simultaneously change the display state of the first pixel and the display state of the second pixel from the second display state to the first display state and then change the conduction state of the first transistor and the conduction state of the second transistor to the on state or the off state.

7. The method of driving the electro-optical apparatus according to claim 6,
wherein the first pixel further includes pixel particles that are provided between the first common electrode and the first pixel electrode;
wherein the second pixel further includes pixel particles that are provided between the second common electrode and the second pixel electrode; and
wherein, in controlling the voltages that are applied to the first scanning line, the second scanning line, the first data line and the common electrode wiring, the driving circuit periodically changes the voltage applied between the first common electrode and the first pixel electrode and the voltage applied between the second common electrode and the second pixel electrode between a first voltage and a second voltage.

8. The method of driving the electro-optical apparatus according to claim 5,
wherein, in selecting an on state or an off state as a conduction state of the first transistor, the second scanning line is put into a high-impedance state.

9. The method of driving the electro-optical apparatus according to claim 5,
wherein the electro-optical apparatus further includes a third pixel having a third transistor that is electrically connected to the first scanning line, a third pixel electrode and a third common electrode that opposes the third pixel electrode, and further includes a second data that is electrically connected to the third transistor, and
wherein a switching characteristic of the third transistor has hysteresis;
wherein a voltage applied to the second data line is controlled by the driving circuit;
wherein an on state or an off state is selected as a conduction state of the third transistor in accordance with a voltage applied between the first scanning line and the second data line; and
wherein, in selecting an on state or an off state as a conduction state of the first transistor, the conduction state of the third transistor is maintained without being changed by putting the second data line into a high-impedance state.
